(19) United States
(12) Patent Application Publication
(10) Pub. No.: US 2022/0240510 A1
(43) Pub. Date: Aug. 4, 2022

(54) SURFACE-TREATING WOOD TO PREVENT DISCOLORATION

(71) Applicant: Troy Corporation, Florham Park, NJ (US)

(72) Inventor: Geoffrey Vern Webb, Quakertown, PA (US)

(21) Appl. No.: 17/721,909

(22) Filed: Apr. 15, 2022

Related U.S. Application Data
(62) Division of application No. 16/369,322, filed on Mar. 29, 2019, now abandoned.
Application No. 16/369,322 is a division of application No. 15/616,834, filed on Jun. 7, 2017, now abandoned.
Application No. 15/616,834 is a continuation-in-part of application No. 15/141,673, filed on Apr. 28, 2016, now abandoned.
(60) Provisional application No. 62/175,391, filed on Jun. 14, 2015.
(60) Provisional application No. 62/188,348, filed on Jul. 2, 2015.

(51) Int. Cl. A01N 43/80; A01N 25/30; A01N 25/04; C09D 5/14; B05D 1/18; B05D 7/06; B27K 3/34; C09D 7/45; C09D 7/40; C09D 7/63; C09D 7/20; B27K 3/08; B27K 3/50

(52) U.S. Cl. CPC A01N 43/80; A01N 25/30; A01N 25/04; C09D 5/14; B05D 1/18; B05D 7/06; C08K 5/47; C09D 7/45; C09D 7/69; C09D 7/63; C09D 7/20; B27K 3/08; B27K 3/50; B27K 3/343

(57) ABSTRACT

An aqueous dispersion of octylisothiazolinone has been found to be useful for delivering OIT to wood for protecting the wood from fungal discoloration. The OIT dispersion can be applied to the wood to develop a protective barrier of preservative relatively at or near the exterior surface of the woodpiece.

### CROSS-REFERENCE TO RELATED APPLICATIONS

This application is a divisional application of U.S. Ser. No. 16/369,322, filed Mar. 29, 2019, which is a divisional application of U.S. Ser. No. 15/616,834, filed Jun. 7, 2017, which is a continuation-in-part of U.S. Ser. No. 15/141,673, filed Apr. 28, 2016, which claims priority of U.S. Ser. No. 62/175,391, filed Jun. 14, 2015, and of U.S. Ser. No. 62/188,348, filed Jul. 2, 2015. Each of these applications is hereby incorporated by reference in its entirety.

### BACKGROUND OF THE INVENTION

### Field of the Invention

The present invention relates to dispersions of octylisothiazolinone and to products and pressure-treating processes for increasing the resistance of dimensioned wood against discoloration by surface mold and sapstain fungi.

### Description of the Related Art

Protecting wood from fungal discoloration by means of spraying, dipping or immersing under pressure in a liquid solution of octylisothiazolinone (hereinafter referred to as “OIT”) is known. Protecting the cellulosic fibers of wood from structural attack by cellulose-eating fungi by means of pressure-treating the wood in a preservative is also known. The preservative may be in the form of a true solution or a dispersion containing nanometer-sized particles, in which the particles intentionally sized small enough to penetrate cellulosic fibrils of the wood.

OIT solutions are publicly used to combat molds that have pigmented spores, such as Stachybotrys chartarum and Penicillium sp., as well as sapstain fungi that have pigmented hyphae, such as Aureobasidium pullulans.

Wood contains four main types of material: cellulose, hemi-cellulose, lignin, and extractives. Cellulose and hemi-cellulose make up the fibril structure of wood cell walls. Lignin acts as a poly-phenolic glue that holds the cellulosic fibrils together. Extractives are the sugars, starches, oils, etc. that generally reside within the wood cell voids along with water.

Fibrils are groups of cellulosic molecules in bundles of about 12 nm or less diameter, typically about 2 to 4 nm diameter. Cellulose is the primary fibril component. Hemicellulose, which is considered a chemical precursor to cellulose, is also present in the fibrils.

Fibrils bundle together to form the wood fiber within a cell wall. Each cell wall is comprised of four layers: a primary cell wall layer, an SI layer, an S2 layer, and an inner cell wall layer. The fibrils are oriented in different directions, depending upon which layer of the cell wall the fibril was formed in.

The primary cell wall is a relatively thin, outermost layer of the cell wall. Fibrils in the primary cell wall layer can be oriented in various directions; fibril direction in the primary cell wall layer is amorphous.

An SI layer is located inside the primary cell wall. The SI layer is about 0.25 to about 0.50 um thick with a helical/spiral direction to the fibrils.

An S2 layer of the cell wall is about 0.5 to about 1.0 um thick with a generally longitudinal direction.

An inner cell wall is a thin layer that makes up the interior surface of the wood cell. The fibrillar direction of the Tertiary cell wall is amorphous.

Due to the structure of cellulose, fibrils, and cell walls, water has interesting effects on wood. First, water can fill the cellular voids and water can also adsorb onto the cellulose (not to be confused with absorption into the cellulose). A hydrogen-bonding interaction occurs between the cellulose and the adsorbed water. Consequently, when wood is dried, the first water that is driven off is water located within the cellular voids (also known as “free water”). The last bit of water to be driven off is the water adsorbed onto the fibrils of the cell wall (also known as “bound water”). Wood shrinks and swells with the addition or removal of bound water. Additional energy is required to remove bound water due to hydrogen bonding. Aqueous solutions, being solutions of water, are typically adsorbed into the wood fiber.

For the present purposes, “fungal attack” means infestation by wood destroying fungi (typically Basidiomycetes fungi), which attack and digest the cell wall constituents: cellulose, hemi-cellulose, and lignin. By digesting the cell wall, wood-destroying fungi undermine the strength and integrity of the wood. Preservative treatments for wood have historically focused on protecting the cell wall structural integrity, and thereby the durability of the wood.

It is important to distinguish between fungal attack and fungal discoloration. “Fungal discoloration” means infestation by fungi that digest extractives that are located within the cell void, without diminishing the cell wall structural integrity.

For example, pressure treating with preservatives is a method of forcing preservatives into the structure of the cell wall. In the method, one or more preservatives are forced from the sawn surfaces of a board into the center of the board and cellulose-eating fungi are killed when they come into contact with the biocide. Most pressure treating processes utilize biocide dissolved in a liquid solution or a nano-dispersion, and attempt to force the biocidal solution or the nano-dispersion between the fibrils of the cell wall in order to thoroughly penetrate and protect from fungal attack.

The nano-dispersions usually employ preservatives in the form of aqueous dispersions. The dispersions contain tiny biocidal particles that are sufficiently small that they can be forced by pressure into the cell wall fibers. The aqueous solutions swell the fibrils and the tiny particles are forced among the fibrils. Because wood-destroying fungi grow among and eat the fibrils, this is an effective way to bring the biocidal particles into contact with wood destroying fungi. However, the treatments used to combat wood-destroying fungi are inadequate against wood-discoloring molds and fungi.

Previous researchers have also described special solvents for dissolving OIT, and emulsions that facilitate dilution of concentrated OIT-containing formulations to produce OIT solutions. The solvents and emulsions are said to overcome problems that would otherwise arise from non-homogeneous OIT emulsions or from phase separation of OIT solutions.

Wood-discoloring molds and fungi are presently a major of concern in the lumber industry. The simple fact is that consumers do not like to buy discolored, moldy-looking wood. Consumers are not satisfied with strong lumber that is looks unhealthy. Wood-discoloring molds and fungi do not negatively impact the structural integrity of the wood, because they do not digest the cell wall. The hyphae of wood-discoloring fungi grow within the cell voids, not within the cell walls. Consequently, the traditional approach of forcing biocidal solutions or biocidal dispersion into fibrils of the cells walls is inefficient and largely ineffective against wood-discoloring molds and fungi.

Despite the impressive achievements of previous researchers, the wood industry still has a need for improved preservative products that can efficiently increase the resistance of wood and wood products to discoloration by mold and fungi.

### SUMMARY OF THE INVENTION

It has now been discovered that an aqueous dispersion of OIT in water is surprisingly more effective for increasing the resistance of pressure treated wood to discoloration by mold and fungi, as compared to solutions and nano-dispersions of OIT. The dispersion can be used to create a barrier at or near the exterior of a wood piece that protects the wood piece from fungal discoloration.

In one aspect, the invention is a two-phase composition for inhibiting fungal discoloration of wood by mold having pigmented spores or by sapstain fungi. The two-phase composition includes a disperse phase in the form of solid or liquid particles having a mean average size the range of about 5 to about 50 microns. The disperse phase also includes octylisothiazolinone and a surfactant. The surfactant may be nonionic, preferably a polyalkoxylated ether or polyalkoxylated alcohol. The two-phase composition also includes a continuous liquid phase containing water and, optionally, a rheology modifier such as xanthan gum.

In another aspect, the invention is a process for increasing the resistance of wood to fungal discoloration. The process includes providing a two-phase composition, which two-phase composition includes a disperse phase in the form of solid or liquid particles having a mean average size the range of about 5 to about 50 microns; and a continuous liquid phase, which includes water and, optionally, a thixotropic rheology modifier. The disperse phase also includes octylisothiazolinone and a surfactant.

The process also includes immersing the wood in the two-phase composition under pressure in the range of about 125 psig to about 225 psig to cause the preservative to become concentrated within the cell voids of cells that are located at or near the exterior surface of the wood piece. As a result, the resistance of the wood to discoloration by surface mold and sapstain fungi is increased.

In yet another aspect, the invention is wood having increased resistance to fungal as a result of the process described above.

### BRIEF DESCRIPTION OF THE DRAWINGS

FIG. 1 is a structural formula that illustrates the repeating unit of wood cellulose;

FIG. 2 is a perspective view of a wood fibrillary bundle which illustrates longitudinally arranged molecules;

FIG. 3 is an isometric sectional view of a wood cell wall 6, which depicts a primary cell wall layer 9, an S1 layer 10, an S2 layer 11, and an inner cell wall layer 12;

FIG. 4 is a truncated perspective view of a wood cellular bundle 8, which depicts cell voids 3, wood cells 4, intercellular pits 5, and cell walls 6; and

FIG. 5 is a sectional view of a wood block 13 in which a previously known OIT solution 2 is absorbed within cell walls 6, and cell voids 3, intercellular pits 5, and hyphae of mold having pigmented spores or sapstain fungi 7 are also depicted; and

FIG. 6 is a sectional view of a wood block 14 in which OIT dispersion particles 1 are concentrated within wood cell voids 3, and intercellular pits 5, cell walls 6, and hyphae of mold having pigmented spores or sapstain fungi 7 are also depicted.

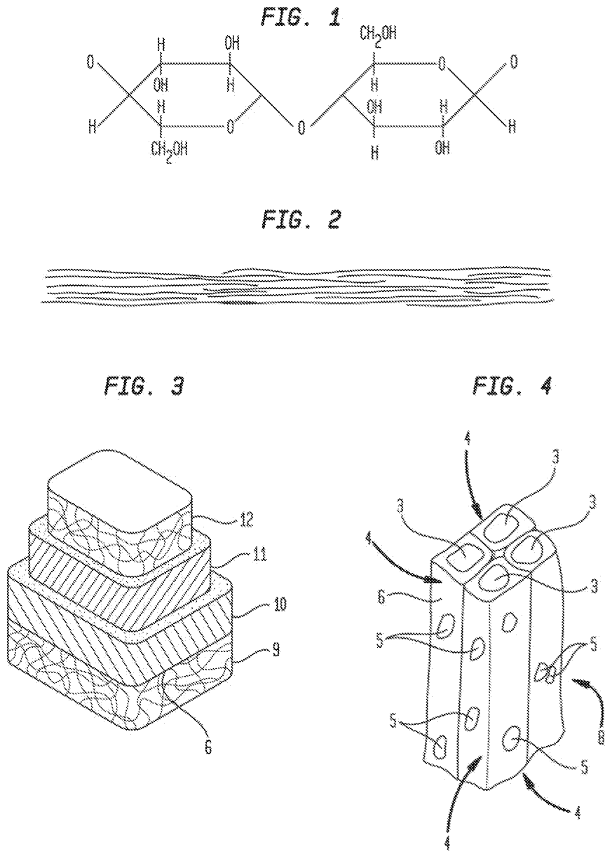

### DETAILED DESCRIPTION OF A PREFERRED EMBODIMENT

In a preferred embodiment, the invention is a two-phase composition for inhibiting wood discoloration by mold having pigmented spores or sapstain fungi.

Referring now to FIG. 6, a disperse phase of the two-phase composition is in the form of solid or liquid particles 1. The particles 1 contain at least octylisothiazolinone and a surfactant. The particles 1 are physically stable at OIT concentrations in the range of about 50 to about 500 ppm, based on the total weight of the dispersion. Preferably, the amount of OIT present in the two-phase composition is in the range of about 50 ppm to about 60 percent by weight. More preferably, the OIT present in the two-phase composition is 2-n-octyl-4-isothiazolin-3-one.

The particles 1 of the inventive dispersion are small enough to move inside the cell voids 3 and travel from one wood cell 4 to another via intercellular pits 5, but are too large to be adsorbed or absorbed within the cell wall 6. The particles 1 of the inventive dispersion are effective at inhibiting discoloring mold having pigmented spores or sapstain fungi, because the particles 1 become concentrated in cell voids 3 where the hyphae 7 of mold having pigmented spores or sapstain fungi grow.

The particles 1 are of a size that permits them to travel within individual wood cells 4, and from one wood cell 4 to another wood cell 4, via intercellular pits 5, without being adsorbed or absorbed by the wood fiber. As explained below, the mean average particle size of the dispersed particles of the present invention is preferably in the range of about 5 to about 50 microns, more preferably about 5 to about 25 microns, and most preferably about 5 to 10 microns. For the present purposes, “mean average” and “arithmetic mean” are synonyms that are both defined as the value obtained by dividing the sum of a set of quantities by the number of quantities in the set.

Movement of treating solution between the cells (through the intercellular pits) is facilitated by the application of pressure. The surface-treating process of the present invention is preferably operated at a pressure in the range of about 125 psig to about 225, more preferably about 125 psig to about 200 psig, and most preferably about 125 psig to about 180 psig.

It is highly recommended that the operator of the wood treating process adjust the operating pressure of the process, by observation and trial-and-error, to optimize the preservative envelope so the that OIT is preferably concentrated within about one-half, more preferably about one-quarter inch, and most preferably about one-eighth of the exterior surface of the wood piece. For the present purposes, “concentrated” means that the concentration of OIT in the envelope portion of the wood piece is at least twice the concentration of OIT in the inventive dispersion that was applied to the wood piece. In contrast, conventional methods that utilize a solution or a nano-particle dispersion typically deposit a concentration of preservative in the wood that is about equal to the concentration of OIT in the solution or nano-particle dispersion that was applied.

Conventional OIT preservatives are solutions or nano-particle dispersions that, under pressure, penetrate the wood piece fully. To the contrary, the inventive dispersion of the present invention penetrates just the outer layers of cells in the wood and does not to penetrate into the depths of the piece of wood. The present invention is a surface treating process, which creates a barrier to invasion of the wood piece by wood discoloring fungi, which usually begin their attack at the surface of the wood piece.

The mean average particle size of the dispersed particles of the present invention is preferably in the range of about 5 to about 50 microns, more preferably about 5 to about 25 microns, and most preferably about 5 to 10 microns. This range of particle size ensures that the dispersed particles of the invention are small enough to be transported through and within the cell voids, yet large enough to be restricted and inhibited in their movement through the intercellular pits.

The particle size range of the inventive dispersion causes the preservative to become more concentrated within the cell voids of cells that are located at or near the outside surface of the wood piece, as compared to conventional preservatives methods, which utilize solutions or nano-dispersions.

Sapstain and mold fungi are most prevalent on the exterior surface of the wood piece, and grow within the cellular voids of wood cells near the he surface of the wood pieces. By concentrating the preservative in the cell voids and near the exterior surface, unlike conventional methods which are intended to fully penetrate all of the cells walls throughout the entire wood piece, to the present invention is more cost-effective and efficacious in controlling the wood-discoloring fungi. The present invention provides maximum protection for the entire wood piece by creating a concentrated preservative envelope about the wood piece.

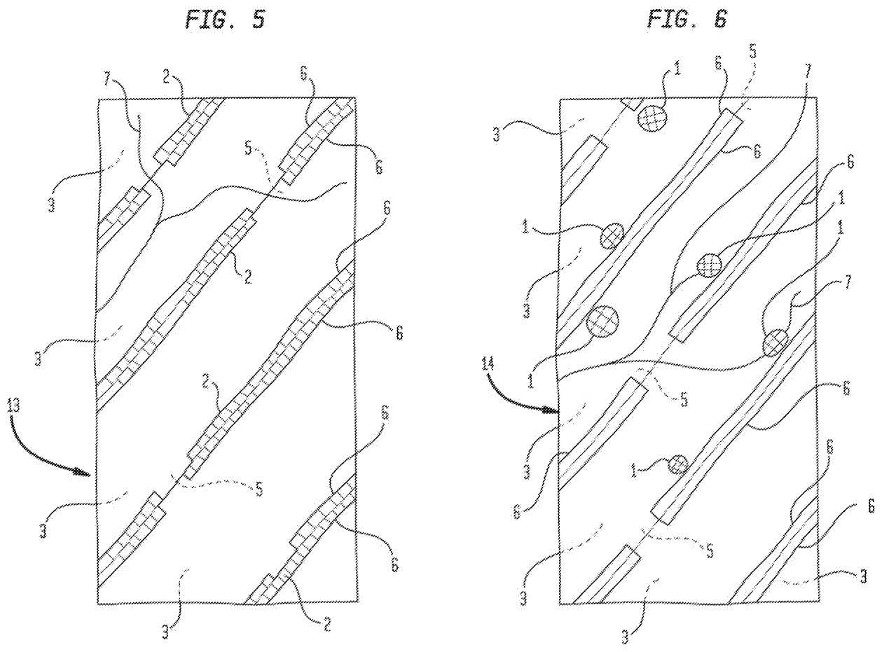

FIG. 5 depicts a previously known OIT solution 2 absorbed or adsorbed within cell walls 6. While concentrating OIT solution 2 within cell walls 6 may be satisfactory for inhibiting wood-destroying fungi that act by entering cell walls 6, it is has now been discovered that OIT dispersion particles 2 concentrated within or immediately adjacent to cell voids 3 are more effective for inhibiting wood discoloration by mold having pigmented spores or sapstain fungi.

A continuous phase of the dispersion is liquid and includes water. A thixotropic rheology modifier is often useful for physically stabilizing the dispersion. Xanthan gum is the preferred thixotropic rheology modifier. When present, the amount of thixotropic rheology modifier should be in the range of about 0.01 ppm to about 0.1 per cent by weight. For the present purposes, “rheology” means the deformation and flow of matter, especially non-Newtonian flow of liquids and plastic flow of solids. For the present purposes, “thixotropic” means having a viscosity that decreases when a stress is applied, as when stirred.

The two-phase composition is conveniently transported in concentrated form and diluted with water at or near the point of use. Preferably, the concentrated form of the two-phase composition contains about 5 percent to about 50 percent OIT by weight. Preferably, the diluted form of the two-phase composition contains about 100 ppm to about 2 percent OIT by weight.

The surfactant is preferably a non-ionic surfactant. For the present purposes, “non-ionic surfactant” means a surfactant without a charged moiety. Polyalkoxylated ethers or polyalkoxylated alcohols are especially preferred for the surfactant. For example, the surfactant may be a polymer of ethylene oxide and propylene oxide. The surfactant may be present in the two-phase composition in an amount in the range of About 0.1 ppm to about 10 percent by weight; preferably, about 1 ppm to about 0.5 percent by weight; more preferably about 2 ppm to about 2 percent by weight.

The following examples and procedures are presented to communicate the invention, and are not meant to limit the invention in any way. Examples described in the present tense are hypothetical examples. Unless otherwise indicated, all references to parts, percentages or proportions are based on weight.

### EXAMPLE 1

### Test Procedure

Resistance to attack by surface mold and sapstain fungi was measured in accordance with American Wood Protection Association Standard AWPA E29-13, entitled “Antisapstain Field Test Method for Green Lumber”; except that the six-level rating scale specified in the Method was not used. Instead, a five-level rating scale was employed as follows:

| | |
|---|---|
| “0” | indicates no mold growth |
| “1” | indicates less than 10% of the surface area has mold (but more |
| | than 0) |
| “2” | indicates less than 25% mold growth (but more than 10%) |
| “3” | indicates less than 50% mold growth (but more than 25%) |
| “4” | indicates that greater than 50% of the surface area of the board |
| | exhibits mold |

More specifically, the lumber utilized for this test was pressure treated Southern Yellow Pine. The pressure treatment included micronized copper azole at a concentration suitable for protection of wood in above ground environments, and included dichloromethylisothiazolinone and methylisothiazolinone (“CMIT/MIT”) at 48 ppm of active ingredient. Each bundle of lumber contained thirty-five treated boards, each 2 inches thick, 4 inches wide and 4 feet long.

Four bundles were prepared and tested. Bundles No. 1, 2, and 3 were treated, respectively, with OIT dispersions of the invention that contained 100 ppm, 200 ppm and, 300 ppm of OIT based on the total weight of the dispersion. The dispersion of the invention included 2 percent of the surfactant, based on the total weight of OIT in the dispersion.

Bundle No. 4 was treated with a widely known and highly regarded antisapstain product, which is commercially available from Arch Wood Protection, Inc. of 360 Interstate North Parkway Suite 450 Atlanta, Ga., US.A, under the tradename Wolman® WE. Wolman® WE is a 45% solution of OIT in a glycol-based solvent. For this test, Wolman® WE was diluted with water to produce a solution containing 100 ppm of OIT.

As specified in the Method, each of the bundles was surrounded by lumber that was not treated with OIT, and was covered in plastic to retain moisture. The bundles were then stored undercover in central South Carolina.

### EXAMPLE 2

### Test Results

Ratings were developed for the OIT-containing boards of each of the four bundles, and separately for the OIT-free perimeter boards of each bundle, by inspecting the individual boards and rating them based on the amount of surface area on each board covered by mold. The five-level rating system described above was utilized to rate the boards. Each board was evaluated after being stored undercover for 30 days, and again after being stored undercover for a total of 90 days.

The tally of OIT-containing board ratings within each bundle, and also of the OIT-free perimeter boards, is shown in the Table below. The mean average of the tallied board scores was calculated to determine the bundle's score. The mean average score for each bundle determines its PASS/FAIL rating, with a FAIL defined as an average score of 2 or greater.

TABLE

| | | | PASS/ | Mean | | | | | |
|---|---|---|---|---|---|---|---|---|---|
| | Storage | INVENTION/ | FAIL* | Average | Frequency of each Board | | | | |
| Bundle | Time | COMPARISON | for | Rating in | Rating in Bundle: | | | | |
| No. | (days) | [form of OIT+] | Bundle | Bundle | 0 | 1 | 2 | 3 | 4 |
| N/A | 30 | COMPARISON | FAIL | 2 | 0 | 2 | 8 | 9 | 0 |
| | | [No OIT] | | | | | | | |
| 1 | 30 | INVENTION A | PASS | 0 | 26 | 6 | 2 | 1 | 0 |
| | | [100 ppm OIT | | | | | | | |
| | | in Dispersion] | | | | | | | |
| 2 | 30 | INVENTION B | PASS | 0 | 29 | 6 | 0 | 0 | 0 |
| | | [200 ppm OIT | | | | | | | |
| | | in Dispersion] | | | | | | | |
| 3 | 30 | INVENTION C | PASS | 0 | 26 | 6 | 0 | 0 | 0 |
| | | [300 ppm OIT | | | | | | | |
| | | in Dispersion] | | | | | | | |
| 4 | 30 | COMPARISON | PASS | 1 | 14 | 11 | 6 | 3 | 1 |
| | | [100 ppm OIT | | | | | | | |
| | | in Solution] | | | | | | | |
| N/A | 90 | COMPARISON | FAIL | 3 | 0 | 0 | 6 | 8 | 5 |
| | | [No OIT] | | | | | | | |
| 1 | 90 | INVENTION A | PASS | 1 | 22 | 10 | 2 | 1 | 0 |
| | | [100 ppm OIT | | | | | | | |
| | | in Dispersion] | | | | | | | |
| 2 | 90 | INVENTION B | PASS | 0 | 25 | 9 | 1 | 0 | 0 |
| | | [200 ppm OIT | | | | | | | |
| | | in Dispersion] | | | | | | | |
| 3 | 90 | INVENTIONC | PASS | 0 | 29 | 5 | 0 | 1 | 0 |
| | | [300ppm OIT in | | | | | | | |
| | | Dispersion] | | | | | | | |
| 4 | 90 | COMPARISON | FAIL | 3 | 0 | 0 | 3 | 15 | 17 |
| | | [100 ppm OIT in | | | | | | | |
| | | Solution] | | | | | | | |

Legend: OIT means octylisothiazolinone
PASS means an Average Score of 0 or 1.
FAIL means an Average Score of 2 or higher.

The boards with no OIT were those placed around the perimeter of the bundles of the four test bundles. Due to these boards having at least one surface exposed, and being subject to drying, they mostly exhibited mold growth on the interior surfaces, with little mold on the exterior surfaces.

The data presented in the TABLE indicates that, after 30 days of storage the bundles of the invention (Bundles No. 1, 2, and 3) exhibited superior performance at all tested OIT levels, as compared to the perimeter boards with no OIT and to Bundle No. 4, which had been treated with a solution containing 100 ppm of OIT.

The data also demonstrates that all three bundles of the invention (Bundles No. 1, 2, and 3) continued to pass the antisapstain test after 90 days of storage, while the antisapstain product with OIT in solution failed the Test after 90 days of storage. This data is evidence that an OIT dispersion is more effective at protecting wood against sapstain or surface mold discoloration, as compared to a solution of OIT that contains the same concentration of OIT.

The above Examples are intended to better communicate the invention, and do not limit the invention in any way. The invention is defined solely by the appended claims.

What is claimed is:

1. A process for increasing the resistance of wood to fungal discoloration, comprising:
immersing a wood piece in a two-phase composition, the composition comprising:
a disperse phase in the form of liquid particles having a mean average size of about 5 to about 50 microns, wherein the disperse phase comprises an octylisothiazolinone and a surfactant; and
a continuous liquid phase comprising water,
wherein the wood piece is immersed in the composition under pressure of about 125 psig to about 225 psig to cause the octylisothiazolinone to become concentrated within the cell voids of cells that are located at or near the exterior surface of the wood piece.

2. The process of claim 1, wherein the continuous liquid phase further comprises a thixotropic rheology modifier.

3. The process of claim 2, wherein the concentration of the thixotropic rheology modifier in the two-phase composition is in the range of about 0.01 ppm to about 0.1 per cent by weight, based on the total weight of the two-phase composition.

4. The process of claim 1, wherein the mean average size of the particles is in the range of about 5 to about 25 microns.

5. The process of claim 1, wherein the mean average size of the particles is in the range of about 5 to 10 microns.

6. The process of claim 1, wherein the octylisothiazolinone is 2-n-octyl-4-isothiazolin-3-one.

7. The process of claim 1, wherein the concentration of the octylisothiazolinone in the two-phase composition is in the range of about 100 ppm to about 2 percent by weight, based on the total weight of the two-phase composition.

8. The process of claim 1, wherein the surfactant is a non-ionic surfactant.

9. The process of claim 1, wherein the surfactant is a polyalkoxylated ether or polyalkoxylated alcohol.

10. The process of claim 1, wherein the surfactant is a polymer of ethylene oxide and propylene oxide.

11. The process of claim 1, wherein the concentration of the surfactant in the two-phase composition is in the range of about 2 ppm to about 2 percent by weight, based on the total weight of the two-phase composition.

12. The process of claim 1, wherein the concentration of the surfactant in the two-phase composition is in the range of about 1 ppm to about 0.5 percent by weight, based on the total weight of the two-phase composition.

13. The process of claim 1, wherein the octylisothiazolinone is concentrated within the cell voids of wood cells that are located within about one-half inch of the exterior surface of the wood.

14. Wood having increased resistance to attack by surface mold and sapstain fungi produced by the process of claim 1.

15. A process for creating a barrier at or near the exterior of a wood piece to increase the resistance of the wood piece to fungal discoloration, comprising:
immersing a wood piece under pressure in the range of about 125 psig to about 225 psig in a two phase composition, comprising:
a disperse phase in the form of solid or liquid particles having a mean average size in the range of about 5 to about 50 microns,
wherein the disperse phase comprises an octylisothiazolinone and a surfactant; and
a continuous liquid phase comprising water.

16. The process of claim 15, wherein the continuous liquid phase further comprises a thixotropic rheology modifier.

17. The process of claim 16, wherein the amount of the thixotropic rheology modifier is in the range of about 0.01 ppm to about 0.1 per cent by weight, based on the total weight of the two-phase composition.

18. The process of claim 15, wherein the octylisothiazolinone is concentrated within or immediately adjacent to cell voids that are located at or near the exterior surface of the wood piece, and the octylisothiazolinone is not concentrated within wood cell walls.

19. The process of claim 15, which increases the resistance of the wood piece to discoloration by mold having pigmented spores, sapstain fungi, or both.

20. The process of claim 15, wherein the octylisothiazolinone is concentrated within the cell voids of wood cells that are located within about one-half inch of the exterior surface of the wood.

21. The process of claim 20, wherein the octylisothiazolinone is concentrated within the cell voids of wood cells that are located within about one-quarter inch of the exterior surface of the wood.

22. The process of claim 15, wherein the mean average size of the particles is in the range of about 5 to about 25 microns.

23. The process of claim 15, wherein the mean average size of the particles is in the range of about 5 to 10 microns.

24. The process of claim 15, wherein the octylisothiazolinone is 2-n-octyl-4-isothiazolin-3-one.

25. The process of claim 15, wherein the amount of octylisothiazolinone is in the range of about 50 ppm to about 60 percent by weight, based on the total weight of the two-phase composition.

26. The process of claim 25, wherein the amount of the surfactant is in the range of about 0.1 ppm to about 10 percent by weight, based on the total weight of the two-phase composition.

27. The process of claim 15, wherein the amount of the octylisothiazolinone is in the range of about 100 ppm to about 2 percent by weight, based on the total weight of the two-phase composition.

28. The process of claim 27, wherein the amount of surfactant is in the range of about 1 ppm to about 0.5 percent by weight, based on the total weight of the two-phase composition.

29. The process of claim 15, wherein the amount of the octylisothiazolinone is in the range of about 5 percent by weight to about 45 percent by weight, based on the total weight of the two-phase composition.

30. The process of claim 29, wherein the amount of the surfactant is in the range of about 2 ppm to about 2 percent by weight, based on the total weight of the two-phase composition.

31. The process of claim 15, wherein the surfactant is a non-ionic surfactant.

32. The process of claim 15, wherein the surfactant is a polyalkoxylated ether or polyalkoxylated alcohol.

33. The process of claim 15, wherein the surfactant is a polymer of ethylene oxide and propylene oxide.

34. A wood piece produced by the process of claim 15.
